(19) United States
(12) Patent Application Publication
(10) Pub. No.: US 2026/0347575 A1
(43) Pub. Date: Nov. 5, 2026

(54) CELLULOSE COMPOSITE AND RUBBER COMPOSITION CONTAINING SAME

(71) Applicant: HANSOL PAPER CO., LTD., Seoul (KR)

(72) Inventor: Junbae JEON, Daejeon (KR)

(21) Appl. No.: 19/111,852

(22) PCT Filed: Oct. 16, 2023
(86) PCT No.: PCT/KR2023/015920

§ 371 Date: Mar. 14, 2025

(30) Foreign Application Priority Data
Oct. 18, 2022 (KR) 10-2022-0133786

(51) Int. Cl. C08K 9/08; C08L 11/00

(52) U.S. Cl. CPC C08K 9/08; C08L 11/00; C08K 2201/003; C08L 2205/03; C08L 2205/16

(57) ABSTRACT

The present invention relates to a cellulose composite, a manufacturing method therefor, and a rubber composition including same, wherein the cellulose composite comprises cellulose fibers and first and second spacers distributed among the cellulose fibers, the first spacer including an organic monomer or polymer with a hydrophilic-lipophilic balance (HLB) of 8 to 18, the second spacer including an organic monomer or polymer with an HLB of 1 to less than 8. In the cellulose composite according to the present invention, the first spacer distributed among the cellulose fibers inhibits inter-fiber hydrogen bonding by binding to the hydroxyl groups on the surface of the cellulose fibers and the second spacer improves compatibility with resins. Thus, when used as a reinforcement agent in resins, the cellulose composite enhances the dispersibility of cellulose fibers, thereby preventing the degradation of the mechanical properties of the resin.

### TECHNICAL FIELD

The present invention relates to a cellulose composite, specifically, a cellulose composite redispersible in a thermosetting resin, and a rubber composition comprising the same.

### BACKGROUND ART

Thermosetting resins such as synthetic rubber harden, when heat causes a cross-linking reaction between polymer main chains, changing the molecular structure into a three-dimensional network structure. Once hardened, it is difficult to soften again and maintain stable physical properties after molding. In general, it has excellent heat resistance, solvent resistance, chemical resistance, mechanical properties, electrical insulation, etc., and is used in the manufacture of various products that require the above properties, wherein it can be mixed with various fillers or reinforcing agents depending on the purpose and function of the product.

If the above filler or reinforcing agent is an inorganic component, it has the disadvantage of increasing the weight of the molded product due to its high specific gravity and making recycling difficult. Recently, composites with natural cellulose as a reinforcing agent for thermosetting resins have attracted attention.

Cellulose microfibers are formed into a finely dispersed fiber network by going through a refining process that increases the specific surface area by disintegrating the fiber aggregate (pulp) into strands in an aqueous environment. In addition, when the content of cellulose fibers is high during the above-mentioned refining, the viscosity increases excessively, so it is common to perform the refining at a level of 3% to 4%.

These cellulose microfibers may have poor dispersibility when used with hydrophobic thermosetting resins due to hydrophilicity caused by surface hydroxyl groups and coagulation caused by strong hydrogen bonds, and various attempts are being made to prevent this poor dispersibility.

For example, cellulose fibers can be dispersed in a resin after forming a composite by mixing with additives to control hydrophilicity and hydrogen bonding, and since the cellulose fibers are used in the form of a suspension, a drying process to remove water is required.

Freeze-drying is performed using any one of the above drying methods. The freeze-drying has the advantage of effectively inhibiting hydrogen bonding of cellulose.

FIG. 1 schematically illustrates the structure of cellulose fibers obtained by evaporating moisture through freeze-drying. Although the cellulose form is maintained even when the water molecules forming the matrix are evaporated during the drying process, there is a disadvantage in that the drying time is long and the production cost is high.

Meanwhile, the cellulose fiber composite can be dried by heat in a simpler, more productive and cost-effective manner than the freeze-drying, but the thermal drying increases hydrogen bonds between hydroxyl groups on the surface of cellulose, making it difficult to redisperse when mixed with a resin, and thus has limitations in improving the mechanical properties of the resin.

Therefore, the development of a cellulose composite that can ensure dispersion stability within the resin is required.

### DETAILED DESCRIPTION OF THE INVENTION

### Technical Problem

The present invention is intended to solve the above problems and provides a cellulose composite and a method for producing the same, which can achieve excellent dispersibility by improving compatibility with a resin while inhibiting hydrogen bonding during thermal drying by applying spacers between cellulose fibers.

The present invention also provides a rubber composition comprising the cellulose composite.

### Solution to Problem

One aspect of the present invention provides a cellulose composite comprising cellulose fibers and first and second spacers distributed between the cellulose fibers, wherein the first spacer comprises an organic monomer or polymer having a hydrophilic-lipophilic balance (HLB) of 8 to 18, and the second spacer comprises an organic monomer or polymer having an HLB of 1 to less than 8.

Another aspect of the present invention provides a method for producing a cellulose composite, comprising the steps of: (S1) adding a first spacer to a cellulose fiber suspension and stirring to obtain a first emulsion; (S2) adding a second spacer to the first emulsion and stirring to obtain a second emulsion; and (S3) sequentially performing drying and pulverizing the second emulsion or integrating drying and pulverizing processes to obtain a cellulose composite in a powder form.

Another aspect of the present invention provides a rubber composition comprising the cellulose composite, a thermosetting resin and an additive, wherein the cellulose composite is contained in an amount of 0.1 to 50 parts by weight based on 100 parts by weight of the thermosetting rubber.

### Effect of the Invention

In the cellulose composite according to the present invention, the first spacer distributed between cellulose fibers inhibits inter-fiber hydrogen bonding by binding to hydroxyl groups on the surface of the cellulose fibers and absorbing a large amount of water molecules, and the second spacer improves compatibility between cellulose and resin. Thus, when used as a reinforcing agent in resins, the cellulose composite enhances the dispersibility of cellulose fibers, thereby preventing degradation of the mechanical properties of the resin.

### BRIEF DESCRIPTION OF THE DRAWINGS

FIG. 1 schematically illustrates the structure of cellulose fibers obtained by evaporating moisture by freezing and vacuum according to a conventional method.

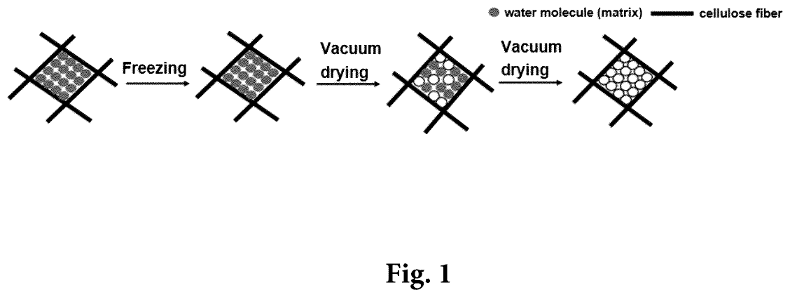

FIG. 2 schematically illustrates the structure of a cellulose composite obtained by evaporating moisture by thermal drying according to one embodiment of the present invention.

FIG. 3 shows optical microscope images showing changes in oil dispersibility and viscosity depending on the first spacer content in the cellulose composite as determined in Experimental Example 1.

FIG. 4 shows cross-sectional images and analysis results of the rubber depending on the second spacer content in the cellulose composite as determined in Experimental Example 2.

FIG. 5 shows cross-sectional images and analysis results of the rubbers manufactured from the rubber compositions of Reference Example (control) and Examples.

FIG. 6 shows comparisons of the mechanical properties of the rubbers manufactured from the rubber compositions of Examples and Comparative Examples.

### BEST MODE FOR CARRYING OUT THE INVENTION

The terms or words used in this specification and claims should not be interpreted as limited to their usual or dictionary meanings, but should be interpreted as having meanings and concepts that conform to the technical idea of the present invention, based on the principle that the inventor can appropriately define the concept of the term in order to explain his or her own invention in the best manner.

In addition, it should be understood that embodiments described in this specification and configurations illustrated in the drawings are only the most preferred embodiments of the present invention and do not represent all of the technical ideas of the present invention, and therefore various equivalents and modifications may be available as of the time of filing this application.

One embodiment of the present invention relates to a cellulose composite having a first spacer and a second spacer distributed between cellulose fibers, wherein the first spacer inhibits hydrogen bonding between fibers by bonding to hydroxyl groups on the surface of the fibers, and the second spacer improves compatibility when blending the cellulose composite with a resin (e.g., rubber resin).

Hereinafter, the components constituting the cellulose composite of the present invention will be described in detail.

The above cellulose fibers can be manufactured from pulp selected from bleached, unbleached, chemical or semi-chemical pulp derived from wood; bleached, unbleached, chemical or semi-chemical pulp derived from non-wood such as cotton, rice straw, bamboo, sugar cane, seaweed, etc.; and recycled pulp (e.g., deinked pulp (DIP), old corrugated container (OCC), etc.). For example, cellulose pulp is an aggregate of fibers having an outermost layer (primary wall) and a plurality of inner layers (secondary walls), and the pulp may be dispersed in water and subjected to a shear force to perform a refining process to produce cellulose fibers forming a microfiber network, and may be modified by oxidation treatment, acid or alkali treatment, etc., as needed.

The cellulose fibers that have undergone the above-described refining process may have a length of several millimeters (e.g., 1 to 5 mm), a width of several tens of microns (e.g., 10 to 60 μm), and an aspect ratio (length/width) of 10 to 500, for example, 50 to 400 or 100 to 300.

Two spacers can be distributed between these cellulose fibers, and specifically, first and second spacers having different HLB values can be distributed between the cellulose fibers.

The above HLB (hydrophilic-lipophilic balance) is an indicator of the balance of hydrophilicity and lipophilicity (hydrophobicity) within a molecule. A large HLB means a large proportion of hydrophilicity, and a small HLB means a small proportion of hydrophilicity.

The first spacer may be an organic monomer or polymer having a relatively higher HLB than the second spacer, for example, an HLB of 8 or more, 10 or more, or 11 or more, and 18 or less, 16 or less, or 14 or less, and may be positioned between cellulose fibers and bonded to hydroxyl groups on the surface of the fibers.

The bonding of the above first spacer and the hydroxyl group on the fiber surface can inhibit hydrogen bonding between fibers, which can achieve excellent dispersibility by maintaining the fiber shape without aggregation of cellulose fibers when drying for manufacturing the composite and dispersing the composite in the resin.

In addition, the first spacer may have a property of not decomposing or volatilizing at 100 °C or higher so as not to be damaged during the drying process of removing water from the cellulose fibers in the manufacture of the composite, and the molecular weight or weight average molecular weight of 100 to 30,000 g/mol, specifically 100 g/mol or more, 200 g/mol or more, 500 g/mol or more or 1,000 g/mol or more, and 30,000 g/mol or less, 10,000 g/mol or less, 8,000 g/mol or less, 4500 g/mol or less, 4000 g/mol or less, 3500 g/mol or less, or 3000 g/mol or less.

In one embodiment of the present invention, the first spacer may be one or more selected from a polyoxyethylene-polyoxypropylene copolymer (HLB 14), polytetrahydrofuran (HLB 11-13), polyethylene glycol-4 monolaurate (HLB 9.8), polyethylene glycol-4 monooleate (HLB 8), polyethylene glycol-8 monolaurate (HLB 11.4), polysorbate 85 (HLB 11), polyoxyethylene (10) cetyl ether (HLB 12.9), polyoxyethylene (20) cetyl ether (HLB 15.7), polyoxyethylene (15) tridecyl ether (HLB 15.4), and an isoprene-maleic anhydride copolymer (HLB 8.9).

In the cellulose composite of the present invention, the first spacer may be contained in a weight ratio of 0.1 to 1.2, specifically 0.3 to 1, of the cellulose fibers, and when the above range is satisfied, the fibers can implement the effect of inhibiting hydrogen bonding during the drying process.

The second spacer may be a more nonpolar material than the first spacer, for example, an organic monomer or polymer having an HLB value of 1 or more, 2 or more, or 3 or more, and less than 8, 7 or less, or 6 or less, and a molecular weight or weight average molecular weight of 40 to 70,000 g/mol, specifically, 100 g/mol or more, 200 g/mol or more, 300 g/mol or more, 500 g/mol or more, or 1,000 g/mol or more, and 50,000 g/mol or less, 10,000 g/mol or less, 8,000 g/mol or less, 4,500 g/mol or less, 4,000 g/mol or less, 3,000 g/mol or less, 2,000 g/mol or less, or 1,000 g/mol or less.

It can be distributed between cellulose fibers together with the first spacer that is bonded to the hydroxyl groups on the fiber surface, thereby improving compatibility with the resin.

The improvement in compatibility by the second spacer can improve the dispersion of the composite in the resin, thereby preventing degradation of the mechanical properties of the resin.

In addition, like the first spacer, the second spacer may have a property of not decomposing or volatilizing at 100 °C or higher so as not to be damaged during the drying process of removing water from the cellulose fibers in the manufacture of the composite.

In one embodiment of the present invention, the second spacer may be one or more selected from alkenyl succinic anhydride (HLB 5-6), fatty acid ester (HLB 3-6), oleic acid (HLB 1.6), sorbitan monostearate (HLB 4.7), sorbitan tristearate (HLB 2.1), sorbitan monopalmitate (HLB 6.7), ethylene glycol monostearate (HLB 2.9), glyceryl monostearate (HLB 3.8), polyethylene glycol-4 dilaurate (HLB 6), 1-butanol (HLB 4.4), 1,4-butanediol (HLB 7.6), isopropyl alcohol (HLB 5.3), a butadiene-maleic anhydride copolymer (HLB 7.5), an ethylene-maleic anhydride copolymer (HLB 7.5), and a butadiene copolymer (HLB 1).

In the cellulose composite of the present invention, the second spacer may be contained in a weight ratio of 0.1 to 4, specifically 0.5 to 3.5, of the cellulose fibers, and when the above range is satisfied, an effect of improving compatibility between the fiber and the polymer can be realized.

In addition, in order to secure the effect of inhibiting hydrogen bonds between fibers of the cellulose composite of the present invention and compatibility between the fiber and the polymer, it is advantageous for the weight ratio of the first spacer and the second spacer to satisfy the range of 1:1 to 1:5, specifically 1:1.5 to 1:3.

The cellulose composite of the present invention can be manufactured by a method comprising the steps of: (S1) adding a first spacer to a cellulose fiber suspension and stirring to obtain a first emulsion; (S2) adding a second spacer to the first emulsion and stirring to obtain a second emulsion; and (S3) thermal drying and pulverizing the second emulsion to obtain a cellulose composite in a powder form.

The cellulose fiber suspension may be obtained by dispersing the pulp of the fiber aggregate in water at a concentration of 1 to 50 wt %, for example 4 to 30 wt % and stirring it, and the stirring may be performed at 1000 to 3000 rpm for 5 to 30 mins.

In the present invention, the stirring may be performed using a rotary mixer, an ultrasonic homogenizer, a homo mixer, or the like.

When the first spacers are added to the cellulose fiber suspension and stirred, an emulsification occurs in which the first spacer with a high hydrophilicity ratio of HLB in the range of 8 to 18 binds to hydroxyl groups on the surface of the cellulose fibers to form aggregates, thereby obtaining a first emulsion. Through the above emulsification, the first spacers are positioned between the cellulose fibers and can inhibit hydrogen bonding between the fibers during the subsequent drying process.

In one embodiment of the present invention, the stirring to obtain the first emulsion may be performed at 1000 to 3000 rpm for 20 to 40 mins (e.g., 30 mins).

When the second spacers are added to the first emulsion and stirred, a second emulsification occurs in which the second spacer with a lower HLB value than the first spacer, i.e., an HLB of 1 to less than 8 or 3 to 6, forms aggregates with the first spacers distributed between cellulose fibers, thereby obtaining a second emulsion. Through the above second emulsification, the second spacer may improve compatibility with the resin by achieving uniform distribution of the first spacer.

In one embodiment of the present invention, the stirring to obtain the second emulsion may be performed at 1000 to 3000 rpm for 20 to 40 mins (e.g., 30 mins).

In the second emulsion, the first spacer particles may have a diameter of 0.1 to 2 μm, and the second spacer particles may have a diameter of 1 to 200 μm.

Then, the second emulsion may be loaded onto a tray, dried with heat, and then pulverized to obtain a cellulose composite in a powder form.

The thermal drying may be performed at 100 to 120 °C or 105 to 110 °C for 20 to 30 hours (e.g., 24 hours).

Another method for obtaining a cellulose composite without going through the sequential processes of mixing, drying, and pulverizing of emulsion as described above may include integrating the described series of processes using a functionalized mixer.

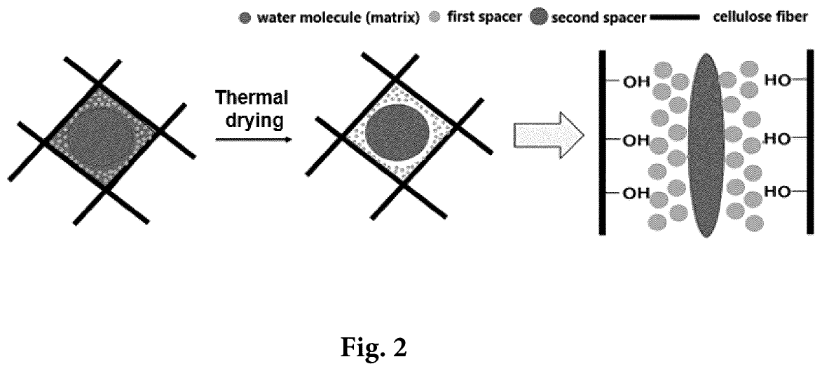

FIG. 2 schematically illustrates the structure of a cellulose composite obtained by evaporating moisture by thermal drying according to one embodiment of the present invention, wherein after drying is completed, the cellulose fibers maintain their shape, and the first spacer distributed between cellulose fibers binds to hydroxyl groups on the surface of the cellulose fibers, thereby inhibiting hydrogen bonding between the fibers, and the second spacer is distributed between the cellulose fibers together with the first spacer bonding with hydroxyl groups on the surface of the fibers, thereby improving compatibility with the resin.

Therefore, the cellulose composite of the present invention may improve the dispersibility of cellulose fibers when used as a reinforcing agent in the resin, thereby preventing degradation of the mechanical properties of the resin.

Accordingly, the present invention provides a rubber composition comprising a cellulose composite, a thermosetting rubber, and an additive.

The thermosetting rubber may be one or more selected from chloroprene rubber, butadiene rubber, acrylonitrile butadiene rubber, styrene butadiene rubber, hydrogenated acrylonitrile butadiene rubber, ethylene propylene diene rubber, chlorinated polyethylene rubber, natural rubber, isoprene rubber, butyl rubber, and silicone rubber.

In the rubber composition, the cellulose composite, which is a biomass used as a reinforcing agent of the thermosetting rubber as a matrix, may be contained in an amount of 0.1 to 50 parts by weight, specifically 1 to 30 parts by weight, more specifically 3 to 25 parts by weight or 3 to 20 parts by weight based on 100 parts by weight of the thermosetting rubber. If the content of the cellulose composite is less than 0.1 parts by weight, it is difficult to sufficiently implement the function as a reinforcing agent, and if it exceeds 50 parts by weight, it may cause a decrease in the dispersion stability of the composite and a consequent deterioration in the mechanical properties of the thermosetting rubber.

The additive may be used as an auxiliary agent for improving the processability and physical properties of the rubber composition, and specifically may include one or more selected from a pigment (e.g., carbon black), an antioxidant (e.g., octylated diphenylamine), a crosslinking accelerator (e.g., N,N′-ethylene-thiourea), and a crosslinking agent (e.g., zinc oxide), and the content thereof may be appropriately selected within a range commonly used in the field of manufacturing rubber products.

The rubber composition may be obtained by adding the cellulose composite, the thermosetting rubber, and the additive to an internal batch mixer such as a BANBURY mixer and stirring at 5 to 100 rpm at 40 to 150 °C for 1 to 30 minutes, and then the composition may be compression molded and cooled to produce a rubber product.

### EMBODIMENTS FOR CARRYING OUT THE INVENTION

Hereinafter, in order to help understand the present invention, examples will be given in detail. However, the embodiments according to the present invention may be modified in various different forms, and the scope of the present invention should not be construed as being limited to the following embodiments. Embodiments of the present invention are provided to more fully describe the present invention to those of ordinary skill in the art.

### Manufacturing Example 1

Bleached kraft pulp (length: 1-5 mm, width: 20-40 μm) was dispersed in water at a concentration of 3 wt % and stirred at 1000 to 3000 rpm for 10 minutes to obtain a cellulose fiber suspension, and a polyoxyethylene (POE)-polyoxypropylene (POP) copolymer with an average molecular weight of 2000 g/mol and an HLB of 14 as a first spacer was added to the cellulose fiber suspension and stirred at 1000 to 3000 rpm for 30 minutes to obtain a first emulsion (viscosity at 25 °C: 3000-4000 cP).

Alkenyl succinic anhydride (HLB 5-6) (molecular weight 350 g/mol) having a lower HLB than the first spacer as a second spacer was added to the first emulsion and stirred at 1000 to 3000 rpm for 30 minutes to obtain a second emulsion (viscosity at 25 °C 3500-4500 cP).

The second emulsion contains cellulose fibers, first spacer particles, and second spacer particles in a weight ratio of 1:1:3 as a solid content, and the first spacer particles are distributed with a diameter of 0.1 to 2 μm, and the second spacer particles are distributed with a diameter of 1 to less than 200 μm.

Then, the second emulsion was freeze-dried at −30 to −10 °C for 24 to 48 hours and then pulverized with a cutter mill to produce a cellulose composite in a powder form.

### Manufacturing Example 2

Bleached kraft pulp (length: 1-5 mm, width: 20-40 μm) was dispersed in water at a concentration of 3 wt % and stirred at 1000 to 3000 rpm for 10 minutes to obtain a cellulose fiber suspension, and a polyoxyethylene (POE)-polyoxypropylene (POP) copolymer having an average molecular weight of 2000 g/mol and an HLB of 14 as a first spacer was added to the cellulose fiber suspension and stirred at 1000 to 3000 rpm for 30 minutes to obtain a first emulsion.

Alkenyl succinic anhydride (HLB 5-6) (molecular weight 350 g/mol) having a lower HLB than the first spacer as a second spacer was added to the first emulsion and stirred at 1000 to 3000 rpm for 30 minutes to obtain a second emulsion.

The second emulsion contains cellulose fibers, first spacer particles, and second spacer particles in a weight ratio of 1:1:3 as a solid content, and the first spacer particles are distributed with a diameter of 0.1 to 2 μm, and the second spacer particles are distributed with a diameter of 1 to less than 200 μm.

Then, the second emulsion was loaded onto a tray, heat dried at 105 °C for 24 hours, and then pulverized with a cutter mill to produce a cellulose composite in a powder form.

FIG. 2 schematically illustrates the structure of a cellulose composite obtained by evaporating moisture through thermal drying in Manufacturing Example of the present invention.

### Comparative Manufacturing Example 1

A cellulose composite was prepared using the same process as in Manufacturing Example 2, except that sorbitan monooleate having a low HLB of 4.3 was used as a first spacer.

### Comparative Manufacturing Example 2

A cellulose composite was prepared using the same process as in Manufacturing Example 2, except that polyoxyethylene (POE) (20) sorbitan monooleate having a high HLB of 15 was used as a second spacer.

### Comparative Manufacturing Example 3

A cellulose composite was prepared using the same process as in Manufacturing Example 2, except that sorbitan monooleate having a low HLB of 4.3 was used as the first spacer and polyoxyethylene (POE) (20) sorbitan monooleate having a high HLB of 15 was used as a second spacer.

### Manufacturing Example 3

A cellulose composite was prepared using the same process as in Manufacturing Example 2, except that an isoprene-maleic anhydride copolymer having an HLB of 8.9 was used as a first spacer.

### Manufacturing Example 4

A cellulose composite was prepared using the same process as in Manufacturing Example 3, except that a butadiene copolymer (HLB 1) was used as a second spacer.

### Comparative Manufacturing Example 4

A cellulose composite was prepared using the same process as in Comparative Manufacturing Example 3, except that an isoprene-maleic anhydride copolymer having an HLB of 8.9 was used as a first spacer.

### Preparation of Rubber Composition not Containing Cellulose Composite (Control)

### Reference Example 1

100 parts by weight of chloroprene rubber (DENKA PS-40, DENKA) having a Mooney viscosity of 30 to 55 as a thermosetting rubber, 50 parts by weight of carbon black (STATEX N550, BIRLA CARBON KOREA) having a surface area of 40 m²/g as a pigment, 2 parts by weight of octylated diphenylamine (OCTAMINE, Addivant) having a melting point of 80 °C as an antioxidant, 0.5 parts by weight of N,N′-ethylene-thiourea (ETU-80, Rhein Chemie) having a specific gravity of 1.1 as a crosslinking accelerator, and 5 parts by weight of zinc oxide (Hanil Chemical) having a specific gravity of 5.6 as a crosslinking agent were mixed and stirred at 70 °C and 20 rpm for 20 minutes to prepare a rubber composition.

### Preparation of Rubber Composition Containing Cellulose Composite

### Example 1

16 parts by weight of the cellulose composite obtained in Manufacturing Example 1, 100 parts by weight of chloroprene rubber (DENKA PS-40, DENKA) having a Mooney viscosity of 30 to 55 as a thermosetting rubber, 50 parts by weight of carbon black (STATEX N550, BIRLA CARBON KOREA) having a surface area of 40 m²/g as a pigment, 2 parts by weight of octylated diphenylamine (OCTAMINE, Addivant) having a melting point of 80 °C as an antioxidant, 0.5 parts by weight of N,N′-ethylene-thiourea (ETU-80, Rhein Chemie) having a specific gravity of 1.1 as a crosslinking accelerator, and 5 parts by weight of zinc oxide (Hanil Chemical) having a specific gravity of 5.6 as a crosslinking agent were mixed and stirred at 70 °C and 20 rpm for 20 minutes to prepare a rubber composition.

### Example 2

A rubber composition was prepared using the same process as Example 1, except that the composite obtained in Manufacturing Example 2 was used as a cellulose composite.

### Comparative Example 1

A rubber composition was prepared using the same process as Example 2, except that the composite obtained in Comparative Manufacturing Example 1 was used as a cellulose composite.

### Comparative Example 2

A rubber composition was prepared using the same process as Example 2, except that the composite obtained in Comparative Manufacturing Example 2 was used as a cellulose composite.

### Comparative Example 3

A rubber composition was prepared using the same process as Example 2, except that the composite obtained in Comparative Manufacturing Example 3 was used as a cellulose composite.

### Example 3

A rubber composition was prepared using the same process as Example 2, except that the composite obtained in Manufacturing Example 3 was used as a cellulose composite.

### Example 4

A rubber composition was prepared using the same process as Example 2, except that the composite obtained in Manufacturing Example 3 was used as a cellulose composite.

### Comparative Example 4

A rubber composition was prepared using the same process as Example 2, except that the composite obtained in Comparative Manufacturing Example 4 was used as a cellulose composite.

### Experimental Example 1: Evaluation of Dispersibility According to First Spacer Content in Cellulose Composite

A cellulose composite was prepared using the same process as in Manufacturing Example 2, but the content of the first spacer (polyoxyethylene-polyoxypropylene copolymer, HLB 14) was varied in the range of 0 to 10 wt % of the total weight of the composite.

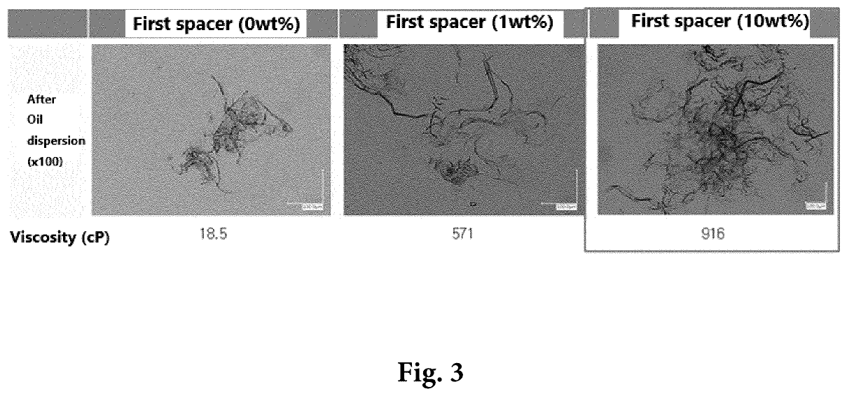

After redispersing the above composite in oil, the dispersibility was evaluated by performing optical microscopy and viscosity measurements, and the results are shown in FIG. 3.

As can be seen in FIG. 3, as the content of the first spacer in the composite increases, the viscosity increases, which is a result of fibrillation and the formation of a 3D network by inhibiting hydrogen bonding between cellulose fibers by the first spacer.

### Experimental Example 2: Evaluation of Compatibility According to Second Spacer Content in Cellulose Composite

A cellulose composite was prepared using the same process as in Manufacturing Example 2, but the content of the second spacer (alkenyl succinic anhydride, HLB 5-6) was varied in the range of 1 to 4 wt % of the total weight of the composite. Using the above composite, a rubber composition was obtained through the same process as in Example 1, and then compression molded to produce a rubber specimen.

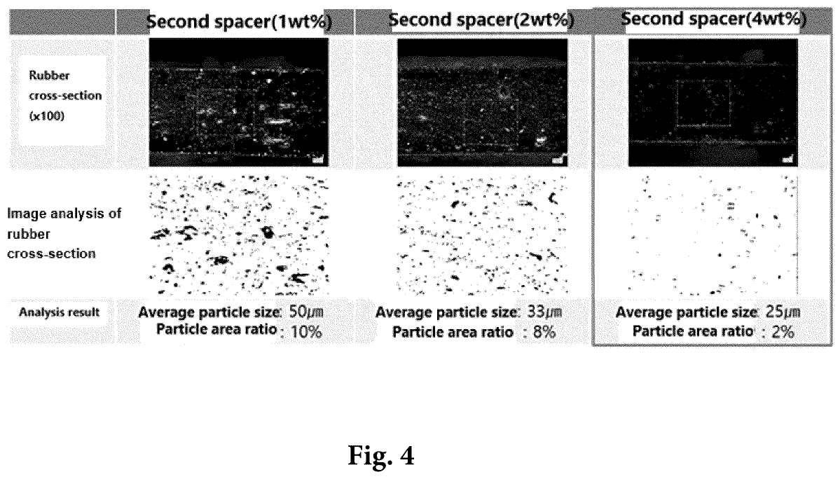

The cross-section of the rubber specimen was photographed using an optical microscope, and the cross-sectional image was analyzed based on pixels of 500×420 in width×height to measure the average particle size and area ratio, and the results are shown in FIG. 4.

As can be seen in FIG. 4, as the content of the second spacer in the rubber specimen increased, the average particle size and area ratio of the cellulose composite dispersed in the rubber decreased, which is a result of improved dispersibility due to improved compatibility with the rubber resin by the second spacer included in the cellulose composite.

### Experimental Example 3: Evaluation of Dispersibility According to Application of Heat-Dried Cellulose Composite

The rubber compositions of Reference Example (control—not containing cellulose composite) and Examples 1 and 2 were each compression molded to produce rubber specimens.

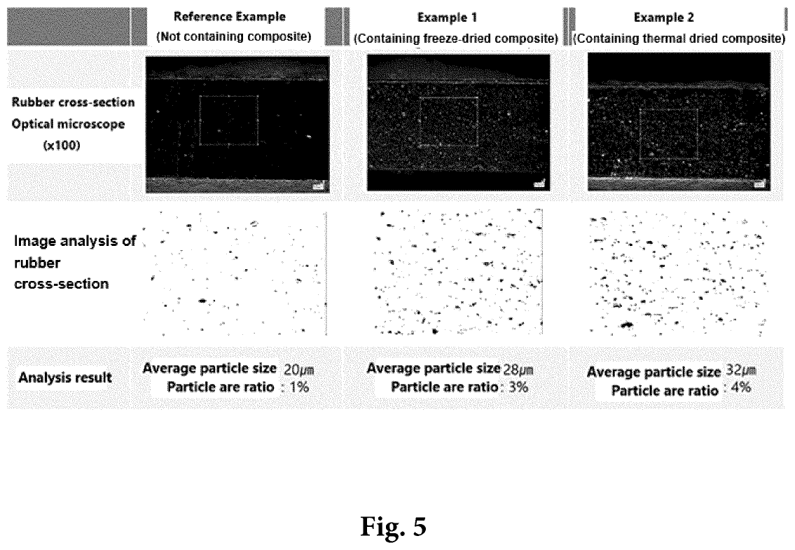

The cross-section of the rubber specimen was photographed using an optical microscope, and the cross-sectional image was analyzed based on pixels of 500×420 in width×height to measure the average particle size and area ratio, and the results are shown in FIG. 5.

As can be seen in FIG. 5, the specimens manufactured from the rubber compositions of Examples 1 and 2 exhibited uniform dispersion.

### Experimental Example 4: Evaluation of Physical Properties According to Application of Cellulose Composite

The rubber compositions of Reference Example and Examples 1 and 2 were each compression molded to produce rubber specimens, and the mechanical properties of the specimens were measured.
Modulus: After cutting the rubber specimens to the dumbbell type specifications of JIS K 6251-1, a tensile strength was determined using UTM (WithlAb). Specifically, the specimen was cut into a size of 4 mm in width×75 mm in length×1 mm in thickness, and the force was measured when the specimen was elongated by 100%, 150%, and 200% at a tensile speed of 254 mm/min at a distance of 20 mm between chucks under the conditions of a temperature of 23 °C and a humidity of 50%.
Hardness: Shore A hardness of rubber specimens was measured according to ASTM D 2240.
Oil resistance: The tensile strength and elongation were measured after placing the rubber specimens in IRM 902 oil at 70 °C for 72 hours.

The results of the above tests are shown in Table 1 below.

TABLE 1

| | | Reference | Example 1 | |
|---|---|---|---|---|
| | | Example 1 | (containing | Example 2 |
| | | (not containing | freeze- | (containing |
| | | cellulose | dried | thermal dried |
| | | composite) | composite) | composite) |
| 100% modulus (MPa) | | 5.8 | 9.5 | 8.9 |
| 150% modulus (MPa) | | 9.4 | 12.7 | 13.0 |
| 200% modulus (MPa) | | 13.1 | 15.6 | 16.7 |
| Hardness (Shore A) | | 70 | 87 | 85 |
| Oil | Δ Tensile | −15.7 | — | −11.5 |
| resistance* | strength (%) | | | |
| (IRM 902, | Δ Elongation | −21.9 | — | −7.6 |
| 70 °C/24 h) | (%) | | | |

*In the evaluation of the oil resistance, Δ tensile strength (%) and Δ elongation (%) are the difference values compared to those of Example 1 including the freeze-dried composite.

In the above Table 1, it can be confirmed that the rubber specimen of Reference Example 1, which does not contain a cellulose composite in the rubber, has low mechanical properties of modulus, hardness, and oil resistance, whereas the rubber specimens of Examples 1 and 2 exhibit high mechanical properties.

### Experimental Example 5: Evaluation of Physical Properties According to Combination of First Spacer and Second Spacer

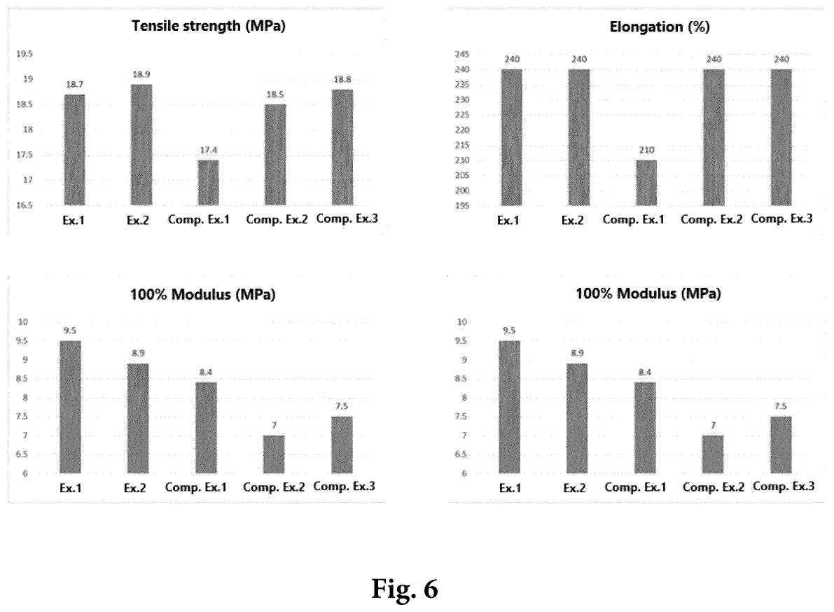

The rubber compositions of Examples 1 to 2 and Comparative Examples 1 to 3 were each compression molded to produce rubber specimens, and the mechanical properties were measured as in Experimental Example 4, and the results are shown in Table 2 and FIG. 6.

TABLE 2

| | | | | Comparative | Comparative | Comparative |
|---|---|---|---|---|---|---|
| | | Example 1 | Example 2 | Example 1 | Example 2 | Example 3 |
| Drying mode | | Freeze | Thermal | Thermal | Thermal | Thermal |
| | | drying | drying | drying | drying | drying |
| Composite | First | POE-POP | POE-POP | Sorbitan | POE-POP | Sorbitan |
| composition | spacer | copolymer | copolymer | monostearate | copolymer | monostearate |
| | | (HLB 14) | (HLB 14) | (HLB 4.3) | (HLB 14) | (HLB 4.3) |
| | Second | Alkenyl | Alkenyl | Alkenyl | POE (20) | POE (20) |
| | spacer | succinic | succinic | succinic | sorbitan | sorbitan |
| | | anhydride | anhydride | anhydride | monostearate | monostearate |
| | | (HLB 5-6) | (HLB 5-6) | (HLB 5-6) | (HLB 15) | (HLB 15) |
| Mechanical | Tensile | 18.7 | 18.9 | 17.4 | 18.5 | 18.8 |
| property | strength | | | | | |
| | (MPa) | | | | | |
| | Elongation | 240 | 240 | 210 | 240 | 240 |
| | (%) | | | | | |
| | 100% | 9.5 | 8.9 | 8.4 | 7.0 | 7.5 |
| | Modulus | | | | | |
| | (MPa) | | | | | |
| | Hardness | 87 | 85 | 83 | 69 | 72 |
| | (Shore A) | | | | | |

In the above Table 2 and FIG. 6, Examples 1 and 2 sequentially apply a first spacer with a high HLB and a second spacer with a low HLB to a cellulose fiber suspension to produce a heat-dried cellulose composite, and then blend the composite with rubber, thereby realizing excellent mechanical properties, whereas Comparative Examples 1 to 3 showed poor mechanical properties.

Specifically, Comparative Example 1 shows that the tensile strength and elongation of the rubber decreased when the first and second spacers having relatively low HLB values, with a small difference in HLB values, were used in the heat-dried cellulose composite. Comparative Example 2 shows that the modulus and hardness of the rubber decreased when the first and second spacers having relatively high HLB values, with a small difference in HLB values, were used. Comparative Example 3 shows that the modulus and hardness decreased when the first spacer having a low HLB value and the second spacer having a high HLB value was sequentially mixed.

The mechanical properties of the rubber compositions of Examples 3 to 4 and Comparative Example 4 were measured using the same method, and the results are shown in Table 3.

TABLE 3

| | | | | Comparative |
|---|---|---|---|---|
| | | Example 3 | Example 4 | Example 4 |
| Drying mode | | Thermal drying | Thermal drying | Thermal drying |
| Composite | First spacer | Isoprene-maleic | Isoprene-maleic | Isoprene-maleic |
| composition | | anhydride | anhydride | anhydride |
| | | copolymer (HLB 8.9) | copolymer (HLB 8.9) | copolymer (HLB 8.9) |
| | Second | Alkenyl succinic | Butadiene | POE (20) sorbitan |
| | spacer | anhydride (HLB 5-6) | copolymer (HLB 1) | monostearate (HLB 15) |
| Mechanical | Tensile | 19.2 | 19.5 | 17.6 |
| property | strength | | | |
| | (MPa) | | | |
| | Elongation | 230 | 240 | 230 |
| | (%) | | | |
| | 100% | 10.4 | 8.2 | 7.1 |
| | Modulus | | | |
| | (MPa) | | | |
| | Hardness | 85 | 82 | 69 |
| | (Shore A) | | | |

From the results in Table 3 above, it can be seen that when a cellulose composite using an isoprene-maleic anhydride copolymer having an HLB of 8.9 as a first spacer and an alkenyl succinic anhydride (HLB 5-6) or a butadiene copolymer (HLB 1) as a second spacer was blended with rubber, the tensile strength, modulus, and hardness were all improved compared to when a second spacer having a relatively high HLB value was used.

1. A cellulose composite comprising cellulose fibers and first and second spacers distributed between the cellulose fibers,
wherein the first spacer comprises an organic monomer or polymer having a hydrophilic-lipophilic balance (HLB) of 8 to 18, and
the second spacer comprises an organic monomer or polymer having an HLB of 1 to less than 8.

2. The cellulose composite according to claim 1, wherein the first spacer has a molecular weight or average molecular weight of 100 to 30,000 g/mol, and the second spacer has a molecular weight or average molecular weight of 40 to 70,000 g/mol.

3. The cellulose composite according to claim 1, wherein the cellulose fibers are obtained from bleached, unbleached, chemical or semi-chemical pulp derived from wood; bleached, unbleached, chemical or semi-chemical pulp derived from non-wood; or recycled pulp.

4. The cellulose composite according to claim 1, wherein the first spacer is one or more selected from a polyoxyethylene-polyoxypropylene copolymer, polytetrahydrofuran, polyethylene glycol-4 monolaurate, polyethylene glycol-4 monooleate, polyethylene glycol-8 monolaurate, polysorbate 85, polyoxyethylene (10) cetyl ether (HLB 12.9), polyoxyethylene (20) cetyl ether, polyoxyethylene tridecyl ether, and an isoprene-maleic anhydride copolymer.

5. The cellulose composite according to claim 1, wherein the second spacer is one or more selected from alkenyl succinic anhydride, fatty acid ester, oleic acid, sorbitan monostearate, sorbitan tristearate, sorbitan monopalmitate, ethylene glycol monostearate, glyceryl monostearate, polyethylene glycol-4 dilaurate, 1-butanol, 1,4-butanediol, isopropyl alcohol, a butadiene-maleic anhydride copolymer, an ethylene-maleic anhydride copolymer, and a butadiene copolymer.

6. The cellulose composite according to claim 1, wherein the first spacer is contained in a weight ratio of 0.1 to 1.2 of the cellulose fibers.

7. The cellulose composite according to claim 1, wherein the second spacer is contained in a weight ratio of 0.1 to 4 of the cellulose fibers.

8. The cellulose composite according to claim 1, wherein the weight ratio of the first spacer and the second spacer is in the range of 1:1 to 1:5.

9. A method for producing a cellulose composite, comprising the steps of:
(S1) adding a first spacer to a cellulose fiber suspension and stirring to obtain a first emulsion;
(S2) adding a second spacer to the first emulsion and stirring to obtain a second emulsion; and
(S3) sequentially performing drying and pulverizing the second emulsion or integrating drying and pulverizing processes to obtain a cellulose composite in a powder form.

10. The method according to claim 9, wherein the stirring in steps (S1) and (S2) is performed at 1000 to 3000 rpm for 20 to 40 mins.

11. The method according to claim 9, wherein the first spacer particles in the second emulsion have a diameter of 0.1 to 2 μm.

12. The method according to claim 9, wherein the second spacer particles in the second emulsion have a diameter of 1 to 200 μm.

13. A rubber composition comprising the cellulose composite according to claim 1, a thermosetting rubber, and an additive,
wherein the cellulose composite is contained in an amount of 0.1 to 50 parts by weight based on 100 parts by weight of the thermosetting rubber.

14. The rubber composition according to claim 13, wherein the thermosetting rubber is one or more selected from chloroprene rubber, butadiene rubber, acrylonitrile butadiene rubber, styrene butadiene rubber, hydrogenated acrylonitrile butadiene rubber, ethylene propylene diene rubber, chlorinated polyethylene rubber, natural rubber, isoprene rubber, butyl rubber, and silicone rubber.

15. The rubber composition according to claim 13, wherein the additive includes one or more selected from carbon black, an antioxidant, a crosslinking accelerator, and a crosslinking agent.

16. The cellulose composite according to claim 3, wherein the non-wood comprises cotton, rice straw, bamboo, sugar cane or seaweed.
